(19) United States
(12) Patent Application Publication
(10) Pub. No.: US 2009/0278344 A1
(43) Pub. Date: Nov. 12, 2009

(54) ENCLOSURE

(75) Inventor: Paul Hadden-Wight, Wokingham (GB)

Correspondence Address: ADVANTIA LAW GROUP, 9035 SOUTH 1300 EAST, SUITE 200, SANDY, UT, 84094, US

(73) Assignee: IRVIN BROTHERS (FLEET WORKS) LTD, WOKINGHAM (GB)

(21) Appl. No.: 12/437,807

(22) Filed: May 8, 2009

(30) Foreign Application Priority Data
May 9, 2008 (GB) 0808472.5

(51) Int. Cl. B42D 3/12; B43K 23/02; B42D 17/00

(52) U.S. Cl. 281/30; 401/131; 281/44

(57) ABSTRACT

There is an enclosure suitable for retaining a paper pad, electronic calculator or such like hand-held device. The enclosure includes a recess adapted to receive a writing implement. When the front cover of the enclosure is closed, a writing implement is securely retained within the recess. When the cover is opened, the writing implement is moved to an accessible position for convenient access.

### CROSS-REFERENCE TO RELATED APPLICATIONS

This invention claims priority, under 35 U.S.C. §119, to the UK Patent Application No. 0808472.5 to Irvin Brothers (Fleet Works) Ltd filed on 9 May 2008 which is incorporated by reference herein.

### BACKGROUND OF THE INVENTION

1. Field of the Invention

The present invention relates to enclosures, specifically to enclosures, such as notebooks and diaries adapted for receiving a writing implement.

2. Description of the Related Art

Lost writing implements represent a source of vexation for scholars and other persons. One solution to the problem of lost writing implements has been to provide notebooks and notepads with holders adapted to receive them, and retain them securely when not in use.

A known solution is to provide a loop affixed to the notepad cover, through which the writing implement is placed when not in use. However, a problem with this solution is that the loop generally only accommodates writing implements of one particular diameter.

The invention seeks to overcome this and other limitations of the art.

### SUMMARY OF THE INVENTION

The present invention has been developed in response to the present state of the art, and in particular, in response to the problems and needs in the art that have not yet been fully solved by currently available enclosures,

According to one embodiment, the invention provides an enclosure for a writing instrument comprising: a recess adapted to receive a writing instrument, and a recess cover pivotally connected to said recess, the recess cover having a closed configuration wherein a writing instrument is capable of being retained within the recess, and an open configuration, such that when the recess cover is moved from the closed to the open configuration, the writing instrument is urged outwardly of the recess into an accessible position.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a section view of an enclosure according to one embodiment of the invention in a closed configuration.

FIG. 2 is a section view of an enclosure according to one embodiment of the invention in a half-open configuration.

FIG. 3 is a section view of an enclosure according to one embodiment of the invention in a fully-open configuration.

FIG. 4 is a plan view of an enclosure according to one embodiment of the invention.

FIG. 5 is a section view of an enclosure according to one embodiment of the invention, having an articulated back cover.

FIG. 6 is a section view of an enclosure according to one embodiment of the invention, having a hinged pad of paper.

FIG. 7 is a section view of an enclosure according to one embodiment of the invention, having a hinged pad of paper and an articulated back cover.

FIG. 8 is a section view of an enclosure according to one embodiment of the invention, featuring a magnetic closure.

FIG. 9 is a section view of an enclosure according to an alternative embodiment of the invention in a closed configuration.

FIG. 10 is a section view of an enclosure according to an alternative embodiment of the invention in an open configuration.

FIG. 11 is a plan view of an enclosure according to one embodiment of the invention in a partially (top) and fully (bottom) open configuration.

The following is a description, by way of example only, and with reference to the figures, of one way of putting the invention into effect.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

The enclosure is generally as shown in FIGS. 1 to 4. The enclosure has a recess cover (1), a recess (2) defined by outer wall (3) and inner wall (4), which are attached to and project substantially perpendicular from and back cover (5), and by two end walls (9) and (10). In the embodiment illustrated, the recess (2) and back (5) covers are of substantially laminar, rectangular appearance. Recess cover (1) and outer wall (3) are pivotally attached along one edge of the recess cover (1), shown at (h). A flexible sheet (6) connects recess cover (1) and the free edge of inner wall (4). Sheet (6) is attached to lid (1) along a line (L), substantially parallel with the pivot line (h) of the recess cover (1). A pad of paper (7), of conventional type, is attached via its spine (8) to the inner wall (4). The recess is provided with end walls (9) and (10).

FIG. 1 illustrates an enclosure of the invention in a closed configuration. Recess cover (1) is in contact with the outer edge (4a) of inner wall (4). The recess cover (1) thus forms the final wall of recess (2), and securely holds the writing instrument (11) in a retained position. The writing instrument (11) is partially encircled by flexible sheet (6). The distance (d) between line of attachment (L) and edge (4a) is small. In the embodiment illustrated, the recess cover (1) also acts as front cover of paper pad (7).

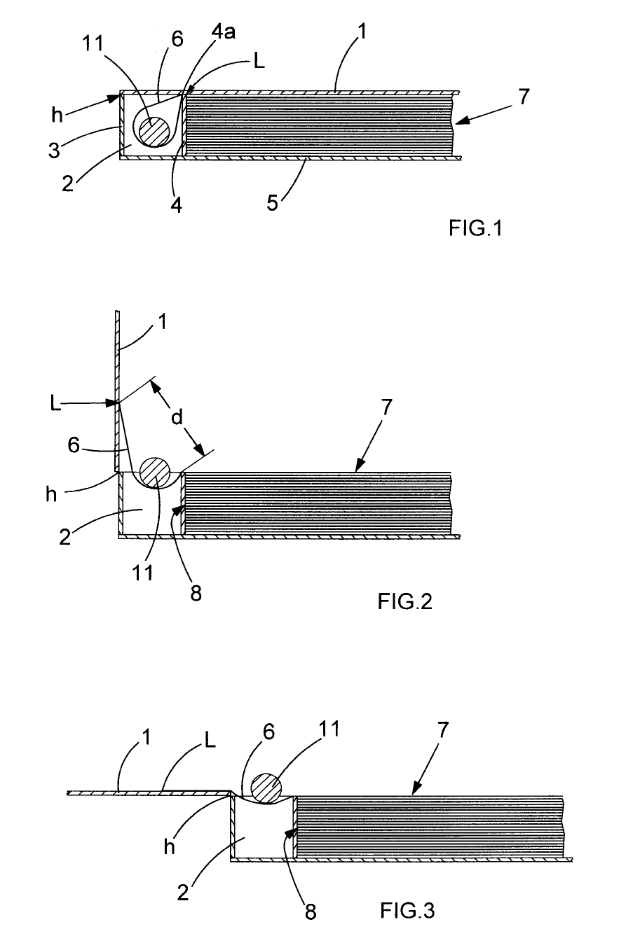

FIG. 2 illustrates the recess cover (1) in a partially open configuration. The distance (d) between line of attachment (L) and edge (4a) is increased relative to the closed configuration. The increase in distance (d) serves to tension and flatten flexible sheet (6), and thus urges writing instrument (11) outwardly of recess (2).

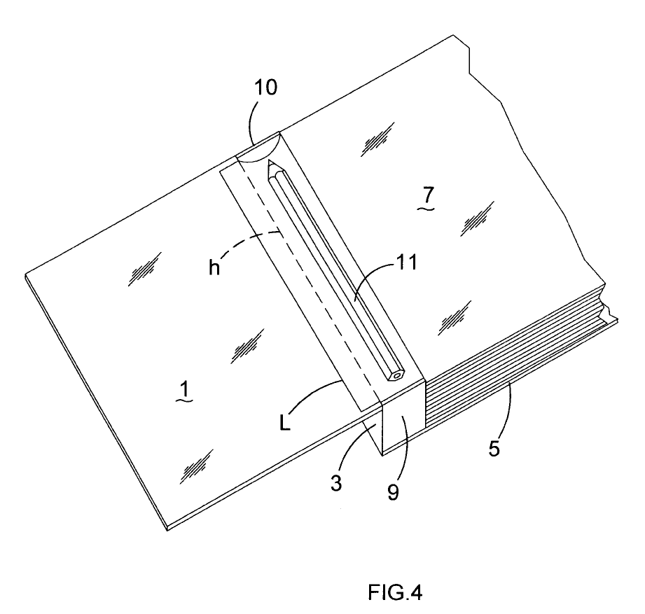

FIG. 3 illustrates the recess cover (1) in a fully open configuration. The distance (d) is at a maximum, and the flexible sheet (6) is substantially flat. The writing implement (11) is substantially fully outside the recess, and can easily be accessed by the user.

To retain the writing implement, the user merely places the writing implement (11) on the flexible sheet (6) with the recess cover (1) in the fully or partially open configuration. Closing the recess cover (1) deforms the flexible sheet (5) into a loop, and lowers the writing implement (11) into the recess (2). When the recess cover (1) is fully closed, it forms the final wall of the recess (2), securely retaining the writing implement (11).

In a preferred embodiment, the enclosure of the invention is adapted to enclose a pad of paper. A pad of paper, as used herein, refers to a number of sheets of paper joined together along a common edge (the spine). Preferred pads of paper include blank and lined paper, but there is no limitation to the invention in this regards, and the skilled person will also appreciate that the enclosure of the invention is equally applicable to guidebooks, reference manuals, diaries, maps and the like.

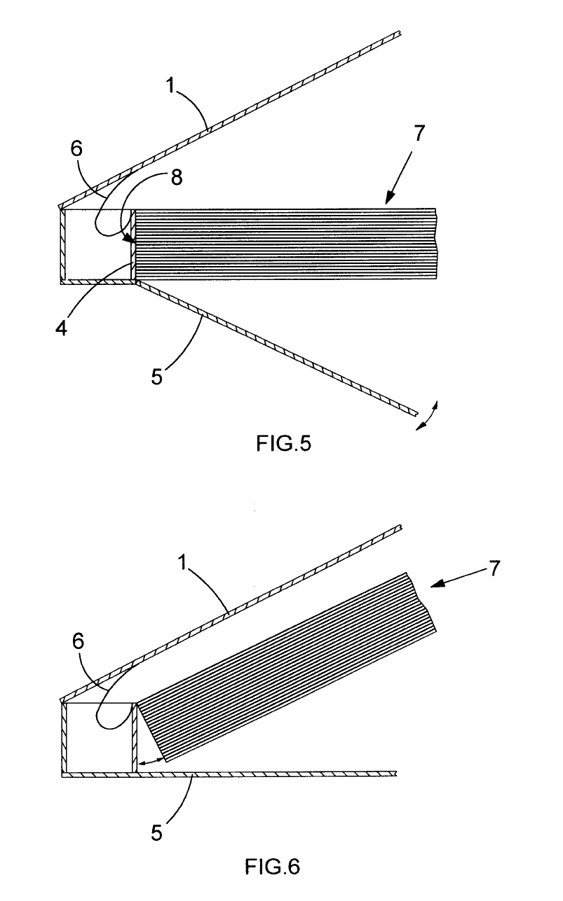

The pad of paper may be permanently affixed to the enclosure. For example, the spine of the pad (8) may be affixed to the face of the inner wall (4) as shown in FIG. 5. Alternatively, the pad of paper may be attached to the inner (4) wall in a pivotal manner, as shown in FIG. 6. This embodiment is advantageous in that it enables easier opening and use of the paper pad.

Alternatively, the paper pad is replaceable. In this embodiment, the paper pad is of a conventional type, and the cover is adapted to retain the paper pad. For example, the cover may feature a sleeve into which a page or pages of the notepad slide. Alternatively, the cover may feature a ring binding to enable it to receive hole punched pages.

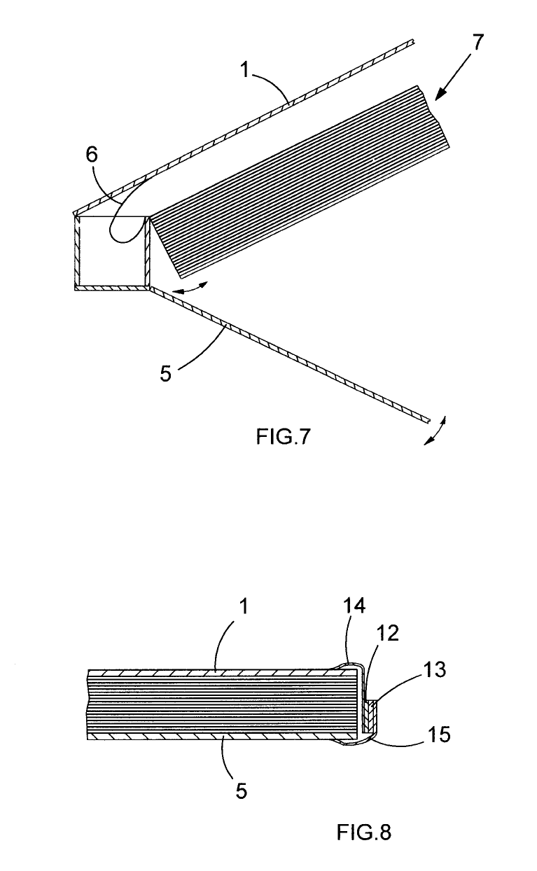

In a further preferred embodiment, the back cover (5) of the enclosure is articulated, as illustrated in FIGS. 5 and 7. This permits easier opening of the paper pad. Articulation is achieved by any one of a number of methods conventional in the art, such as scoring.

The enclosure of the invention may be manufactured from any suitable material. Suitable materials include cardboard, metal and plastics materials. Preferably, the cover is manufactured from cardboard.

There is no limitation on the material that may be use in the preparation of the flexible sheet, provided it fulfills the requirements of flexibility and durability. Suitable materials include paper and plastics materials.

In an alternative embodiment, the flexible sheet may be replaced by one or more flexible strips or filaments, and achieve the same effect.

The skilled person will appreciate that the line of attachment (L) of the flexible sheet to the front cover is significant for the correct operation of the enclosure. The line of attachment should be sufficiently distanced from hinge (h) such that when the front cover is opened, the sheet (6) tends to flatten and urge the writing implement (11) outwardly of the recess.

The dimensions of the flexible sheet (6) are also chosen so as to permit the sheet to “fold” when the recess cover (1) is closed, as shown in FIG. 1, and to become substantially flat when the recess cover (1) is fully open. It may be preferable that the flexible sheet (6) is in fact slightly indented when the front cover is open, so that the writing instrument may be more easily located

Alternatively, the cover may be adapted to receive an electronic device, such as a calculator, electronic organizer, portable computer, mobile telephone or digital music player.

In an alternative embodiment, there is provided a case for a writing implement comprising an enclosure of the invention. The case may be a gift case, presentation case, or storage case.

Various closures may optionally be provided on the enclosure to secure the secure the front cover (1) in a closed configuration. The front (1) or back (5) cover, or both, may be provided with a mechanical engagement means such as a snap, tie, buckle, popper, or hook and loop fastening strips (e.g. Velcro®).

Preferably, the closure is a magnetic closure. In one embodiment, the back cover (5) is provided with a first pad (13), and the front cover (1) is provided with a second pad (12), there being a magnetic attraction between the first (13) and second (12) pads.

Preferably, the first pad (13) is flexibly attached to the back cover (5), such that when the enclosure is in the closed configuration, it is able to come into contact with the second pad (12) and so form a magnetic connection with it.

In a highly preferred embodiment, the first pad (13) is flexibly attached to the back cover (5), and the second pad (14) is flexibly attached to the front cover (1). FIG. 8 illustrates such an arrangement.

The skilled person will understand that it is not necessary for both pads to be magnetic; one pad may for example be non-magnetized steel.

Back cover (5) is provided with a flexible strip (15), which carries a magnet (13). Similarly, front cover (1) is also provided with a flexible strip (14) carrying a magnet (12). When the enclosure is in the closed configuration, the magnets (13, 14) come into contact and form a magnetic connection. This holds the front (1) and back (5) covers together. To open the enclosure, the user applies force to separate the magnets.

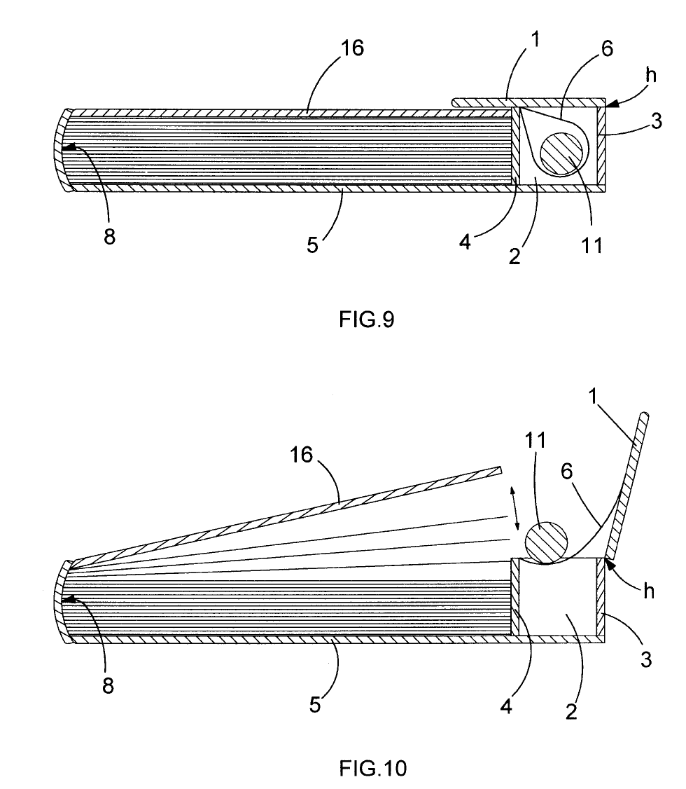

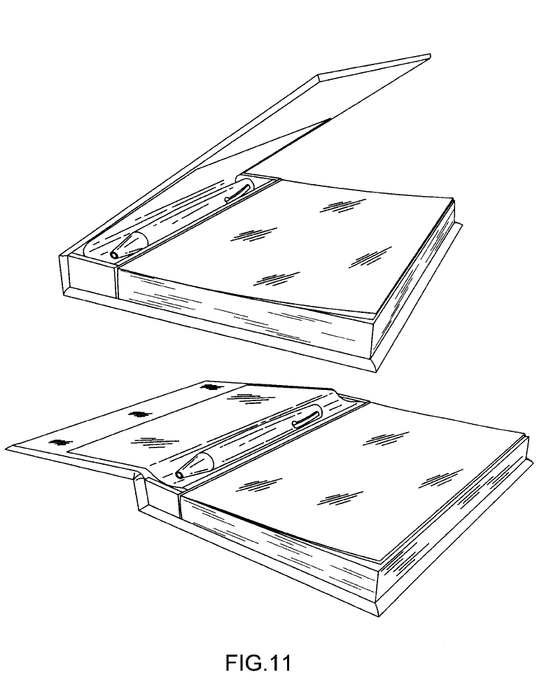

An alternative and preferred embodiment is illustrated in FIGS. 9 and 10. In this embodiment, the enclosure comprises a further pivotally attached cover (16) in addition to recess cover (1). Further cover (16) and recess cover (1) are articulated at opposite sides of the enclosure.

FIG. 9 illustrates section view of an enclosure according to this embodiment of the invention with both the further cover (16) and recess cover (1) in a closed configuration. As can be seen, further cover (16) and recess cover (1) overlap. A closure may be provided to reversibly fasten recess cover (1) and further cover (16) together. For example, there may be a magnetic attraction between recess cover (1) and further cover (16). FIG. 10 illustrates this embodiment of the invention with further cover (16) and recess cover (1) in an open configuration.

A preferred embodiment comprises a sleeve attached to the one of the faces of the pad which may be used to store, for example, loose sheets of paper. In a preferred embodiment, the sleeve is made of cardboard. Preferably, the sleeve has an expandable volume owing to its collapsible concertina walls. The opening of the sleeve preferably faces the spine of the enclosure's cover such that the contents of the sleeve are securely contained when the cover is closed.

The term “writing instrument” will be understood to encompass pens, pencils, and also styli such as those used with touch-sensitive computer screens.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. An enclosure for a writing instrument comprising:
a recess adapted to receive a writing instrument, and
a recess cover pivotally connected to said recess,
the recess cover having a closed configuration wherein a writing instrument is capable of being retained within the recess, and an open configuration, such that when the recess cover is moved from the closed to the open configuration, the writing instrument is urged outwardly of the recess into an accessible position.

2. An enclosure according to claim 1, wherein the recess cover is pivotally connected to a wall of the recess.

3. An enclosure according to claim 1, wherein the recess cover and recess are connected by a flexible sheet which is tensioned when the recess cover is opened.

4. An enclosure according to claim 1 comprising a further pivotally attached cover.

5. An enclosure according to claim 1 further comprising a pad of paper.

6. An enclosure according to claim 5 wherein the spine of the pad of paper is affixed to the enclosure.

7. An enclosure according to claim 5 wherein the pad of paper is pivotally attached to the enclosure.

8. An enclosure according to claim 1 having an articulated back cover.

9. An enclosure according to claim 1 further comprising an electronic device.

10. An enclosure according to claim 1 further comprising a magnetic closure.

11. An enclosure according to claim 10 wherein comprising a first pad flexibly attached to the recess cover, and a second pad flexibly attached to the recess such that when the enclosure is in a closed configuration, the pads can form a magnetic connection.

12. A writing implement case comprising:
enclosure for a writing instrument including:
a recess adapted to receive a writing instrument, and
a recess cover pivotally connected to said recess,
the recess cover having a closed configuration wherein a writing instrument is capable of being retained within the recess, and an open configuration, such that when the recess cover is moved from the closed to the open configuration, the writing instrument is urged outwardly of the recess into an accessible position.

13. An enclosure according to claim 1, further comprising a storage sleeve.
